(19) United States
(12) Patent Application Publication
(10) Pub. No.: US 2026/0094005 A1
(43) Pub. Date: Apr. 2, 2026

(54) METHOD FOR ACCELERATING CLIENT TRAINING BASED ON FEDERATED LEARNING FOR INTELLIGENT PERSONALIZED SERVICES

(71) Applicant: Korea Electronics Technology Institute, Seongnam-si (KR)

(72) Inventors: Young Hwan JEONG, Suwon-si (KR); Tae Min HWANG, Seongnam-si (KR); Won Gi CHOI, Seoul (KR); Sang Shin LEE, Yongin-si (KR); Jin Young LEE, Seoul (KR)

(73) Assignee: Korea Electronics Technology Institute, Seongnam-si (KR)

(21) Appl. No.: 18/941,753

(22) Filed: Nov. 8, 2024

(30) Foreign Application Priority Data
Oct. 2, 2024 (KR) 10-2024-0133661

(51) Int. Cl. G06N 3/098

(52) U.S. Cl. CPC G06N 3/098

(57) ABSTRACT

According to an embodiment, a client training acceleration method includes: searching a model that has a similarity greater than or equal to a predetermined threshold value in a model repository, based on a user request and embedded data; generating a global model by aggregating the searched models with weights; distributing the global model to a user client and a participating client, and requesting training of the distributed global model; and training the global model to reflect pre-stored local on the distributed global model.

### CROSS-REFERENCE TO RELATED APPLICATION(S) AND CLAIM OF PRIORITY

This application is based on and claims priority under 35 U.S.C. § 119 to Korean Patent Application No. 10-2024-0133661, filed on Oct. 2, 2024, in the Korean Intellectual Property Office, the disclosure of which is herein incorporated by reference in its entirety.

### BACKGROUND

### Field

The disclosure relates to a digital twin technology, and more particularly, to a cluster-based federated learning training method.

### Description of Related Art

With the development of hardware and communication technologies, large volumes of data are generated, processed, and stored in various Internet of Things (IoT) devices based on user preference and an installation environment.

Recently, there has been an attempt to analyze and combine IoT data to synchronize with a virtual world (e.g., digital twin) associated with the real world, and a movement to solve problems of the more complex real world by combining various virtual worlds is growing.

However, IoT data collected in this way is typically large volumes of data, and have the feature of being private, reflecting user preference according to domains, and therefore, when data is collected out of local areas, there may be a problem of high communication and storage costs and a personal information problem, and thus, attention on this is required.

Recently, distributed learning g systems called distributed collaborative machine learning (DCML) are spotlighted since they can train high-performance neural networks only with exchange of end-to-end training models while mainlining data in local areas.

However, considering the heterogenous resource environments of IoT devices participating in training, there is a problem that it is difficult to effectively learn unique features of various local data only with a uniform training procedure of existing DCML systems.

### SUMMARY

The disclosure has been developed in order to solve the above-described problems, and an object of the disclosure is to provide a method for accelerating client training based on federated learning for intelligence personalized service, which establishes an AI model cluster which have performed prior federated learning based on data of a plurality of users, allows a user to select an AI model that is most similar to the data pattern of the user from the cluster and trains a global model in the direction of reducing statistical heterogeneity of global model training, and personalizes the global model at high speed when the global model is distributed to the user, thereby training the model at a low cost and simultaneously providing high personalization performance.

According to an embodiment of the disclosure to achieve the above-described object, there is provided a client training acceleration method based on federated learning for intelligent personalized services, the client training acceleration method including: establishing a model repository in a server; searching, by the server, a model that has a similarity greater than or equal to a predetermined threshold value in the model repository, based on a user request and embedded data; generating, by the server, a global model by aggregating the searched models with weights; distributing, by the sever, the global model to a user client and a participating client, and requesting training of the distributed global model; and training, by each client, the global model to reflect pre-stored local on the distributed global model and to update to an optimal personalization model, wherein training the global model includes: training by reflecting local data owned by each client in an isolated local environment; re-acquiring the global model reflecting a result of training by sharing the trained model with the server; and repeating training of the model to reflect local data on the re-acquired global model until a predetermined target performance value is reached.

In addition, searching the model may include selecting a model that has most similar data features and distribution as user data among models, considering only K tokens that have a highest probability priority in a Top-K method which is one of parameters of large language model (LLM).

In addition, training the global model may include: training, by each client, the model according to a deadline requested by the server and requirements on the number of times of training; and, when training the model, generating a check point on a model state for every trained model.

Training the global model may include, when it is difficult for each client to complete training of the current model within the deadline requested by the server, transmitting a weight structure of the check point on the model state which is previously generated to the server.

Training the global model may include: acquiring, by the server, the result of training by each client; updating the global model existing in the server, and simultaneously, updating the model check point of each client in the received model repository with new data and performing indexing in order to re-generate the global model.

Training the global model may include: re-searching a model that has a similarity greater than or equal to the predetermined threshold value, based on the model for which the indexing is performed and an embedding vector according to data features and volumes; and re-generating the global model by aggregating the re-searched models with weights.

Training the global model may include: when the result of training by each client is acquired, receiving, by the server, the maximum results of training by the client through a model update structure within the deadline; and, when the global model existing in the server is updated, updating the global model according to a weighted average of the received results of training by the client.

Training the global model may include: when the indexing is performed, initializing the priority of the model that is used for training by the client in order to guarantee diversity of models to participate in training, and adjusting the priority of the model that is not used for training by the client to be higher than before.

In addition, training the global model may include, when a model is re-searched, re-searching a model that reflects the adjusted priority in order to guarantee diversity of models to participate in training.

According to another embodiment of the disclosure, there is provided a client training acceleration system based on federated learning for intelligent personalized services, the client training acceleration system including: a server configured to search a model that has a similarity greater than or equal to a predetermined threshold value in a pre-established model repository, based on a user request and embedded data, to generate a global model by aggregating the searched models with weights, to distribute the global model to a user client and a participating client, and to request training of the distributed global model; and a plurality of client terminals configured to perform a role of a user client or a participating client, and to train the global model to reflect pre-stored local on the distributed global model and to update to an optimal personalization model, wherein, when training the global model, the plurality of client terminals are configured to train the global model by reflecting local data owned by each client in an isolated local environment, to re-acquire the global model reflecting a result of training by sharing the trained model with the server, and to repeat training of the model to reflect local data on the re-acquired global model until a predetermined target performance value is reached.

According to still another aspect of the disclosure, there is provided a client training acceleration method based on federated learning for intelligent personalized services, the client training acceleration method including: searching, by a server, a model that has a similarity greater than or equal to a predetermined threshold value in a pre-established model repository, based on a user request and embedded data; generating, by the server, a global model by aggregating the searched models with weights; distributing, by the sever, the global model to a user client and a participating client, and requesting training of the distributed global model; and training, by each client, the global model to reflect pre-stored local on the distributed global model and to update to an optimal personalization model.

As described above, according to embodiments of the disclosure, an AI model cluster which have performed prior federated learning based on data of a plurality of users may be established, a user may select an AI model that is most similar to the data pattern of the user from the cluster and may train a global model in the direction of reducing statistical heterogeneity of global model training, and the global model may be personalized at high speed when the global model is distributed to the user, so that the model can be trained at a low cost and simultaneously high personalization performance can be provided.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain an AI model training method of a related-art digital twin;

FIG. 2 is a view provided to explain an AI model training method of a related-art digital twin according to a federated learning (FL) training method;

FIG. 3 is a view provided to explain an AI model training method of a related-art digital twin according to a split learning (SL) training method;

FIG. 4 is a view provided to explain a configuration of a client training acceleration system based on federated learning for intelligent personalized services according to an embodiment of the disclosure;

FIG. 5 is a view provided to explain a detailed configuration of a server according to an embodiment of the disclosure;

FIG. 6 is a view provided to explain detailed configurations of a server and a client according to an embodiment of the disclosure;

FIG. 7 is a flowchart provided to explain a client training acceleration method based on federated learning for intelligent personalized services according to an embodiment of the disclosure;

FIG. 8 is a view provided to explain a model search process through the client training acceleration system based on federated learning for intelligent personalized services according to an embodiment of the disclosure;

FIG. 9 is a flowchart provided to explain a model training process through the client training acceleration system based on federated learning for intelligent personalized services according to an embodiment of the disclosure;

FIG. 10 is a view provided to explain a model training process through the client training acceleration system based on federated learning for intelligent personalized services according to an embodiment of the disclosure;

FIG. 11 is a view provided to explain a process of sharing a model that is trained through the client training acceleration system based on federated learning for intelligent personalized services, with the server according to an embodiment of the disclosure;

FIG. 12 is a view illustrating a result of comparing a personalized model (FACTS) which is trained through the client training acceleration system based on federated learning for intelligent personalized services according to an embodiment of the disclosure, and a model which is trained based on existing local data; and

FIG. 13A and FIG. 13B are views illustrating a result of comparing a result of training by a client which participates in a training method executed through the client training acceleration system based on federated learning for intelligent personalized services according to an embodiment of the disclosure, and a result of training by a client which participates in learning based on existing local data.

### DETAILED DESCRIPTION

Hereinafter, the disclosure will be described in more detail with reference to the accompanying drawings. To clearly illustrate the disclosure, parts which have nothing to do with the descriptions are omitted from the drawings, and the widths, lengths, thicknesses of the components in the drawings may be exaggerated for convenience.

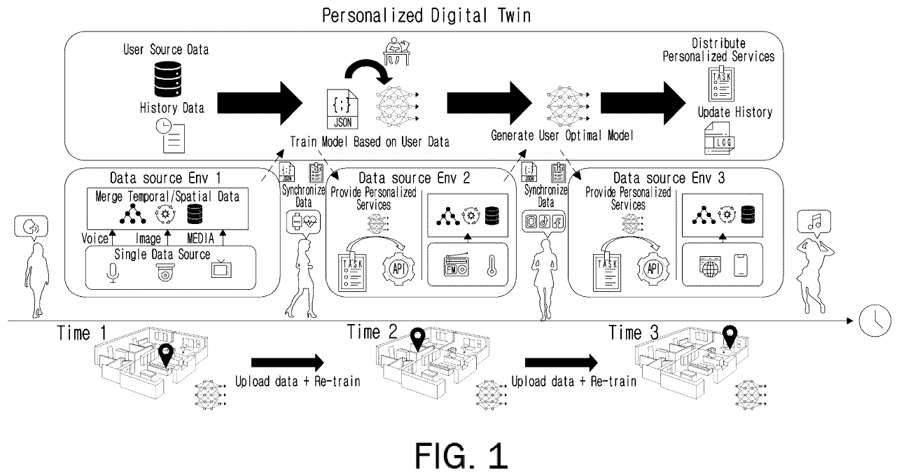

FIG. 1 is a view provided to explain an AI model training method of a related-art digital twin.

According to the AI model training method of the related-art digital twin, when a twin server acquires user data which is associated with the digital twin, the twin server trains a model based on the acquired data (regardless of the volumes and distribution of data).

Accordingly, the AI model training method of the related-art digital twin may have the risk of leakage of user sensitive data, and may have difficulty in providing customized services when the volume of data is small.

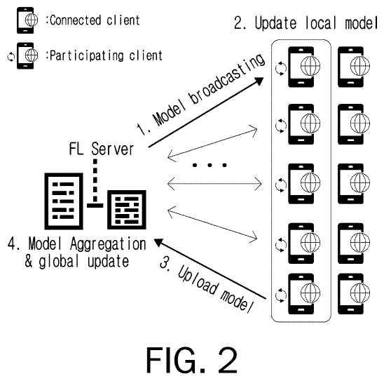

FIG. 2 is a view provided to explain an AI model training method of a related-art digital twin according to a federated learning (FL) training method.

The AI model training method of the related-art digital twin according to the FL training method performs the following operations:
1. Initializing a global model at a server;
2. Selecting a client to participate in global iteration among clients connected with the server, and distributing the global model;
3. Updating, by a participating client, the model by training the received global model in the same training method;
4. Uploading, by the participating client, the updated model to the server within a deadline;
5. Updating, by the server, the global model by aggregating updated models that satisfy training requirements within the deadline, and by obtaining a weighted sum; and
6. Repeating processes 2 to 5 until the performance of the global model reaches a target value.

The FL training method described above may have the disadvantages of having difficulty in adapting to change in a user pattern due to the high initial training cost and the low inference performance that is not optimized to user data.

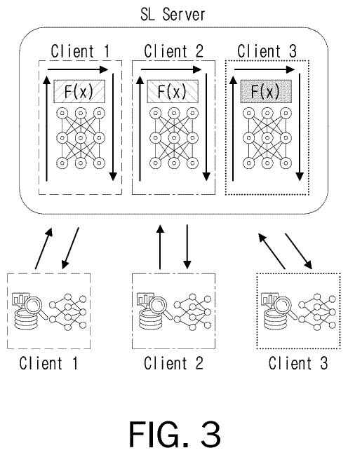

FIG. 3 is a view provided to explain an AI model training method of a related-art digital twin according to a split learning (SL) training method.

The AI model training method of the related-art digital twin according to the SL training method performs the following operations:
1. Splitting, by a server, a global model for training and generating partial models for a client and the server;
2. Transmitting the model for the client among the generated partial models to a client participating in training;
3. Updating the model by cooperating with the partial model for the client and the model for the server in sequence, based on client local data;
4. Aggregating the partial models for the client after updating within a deadline;
5. Combining the partial models and updating the global model;
6. Splitting the partial models and distributing the client model of the server; and
7. Repeating processes 2 to 6 until the performance of the global model reaches a target value.

The SL training method described above should bear server resources which are proportional to the increasing number of users associated with the twin, and may have a problem of degradation of inference performance due to overfitting to user data or insufficient data.

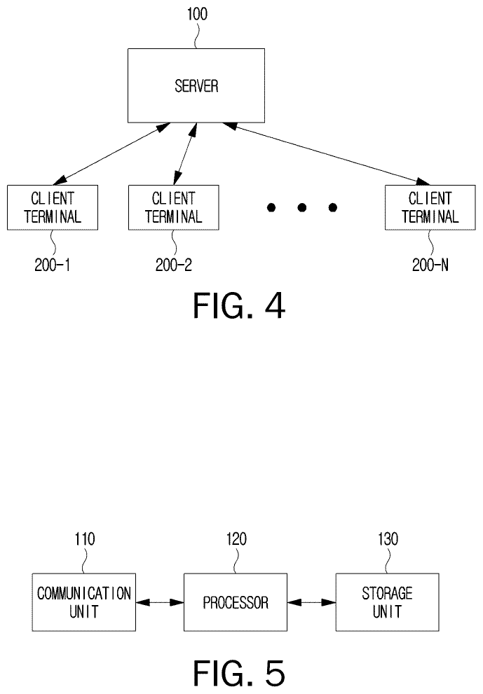

FIG. 4 is a view provided to explain a configuration of a client training acceleration system based on federated learning for intelligent personalized services according to an embodiment of the disclosure.

The client training acceleration system based on federated learning for intelligent personalized services according to the present embodiment (hereinafter, referred to as a ‘system’) may establish an AI model cluster which have performed prior federated learning based on data of a plurality of users, allows a user to select an AI model that is most similar to the data pattern of the user from the cluster and trains a global model in the direction of reducing statistical heterogeneity of global model training, and personalizes the global model at high speed when the global model is distributed to the user, thereby training the model at a low cost and simultaneously providing high personalization performance.

To achieve this, the present system may include a server 100 which distributes a global model to a user client and a participating client, and a plurality of client terminals 200 which perform the role of the user client or participating client and train the global model to reflect local data pre-stored in the distributed global model and to update to an optimal personalization model. In this case, the server 100 may refer to an operating server 100 of a digital twin system, and each client terminal 200 may refer to a personal digital twin.

Specifically, the server 100 may search a model that has a similarity greater than or equal to a predetermined threshold value from a pre-established model repository, based on a user request and embedded data, may generate a global model by aggregating the searched models with weights, may distribute the global model to the user client and the participating client, and may request training of the distributed global model.

The plurality of client terminals 200 may perform the role of the user client or the participating client, and may train the global model to reflect local data pre-stored in the distributed global model and to update to an optimal personalization model.

Specifically, when training the global model, the plurality of client terminals 200 may train the global model by reflecting local data owned by each client in an isolated environment, may re-acquire a global model reflecting the result of training by sharing the trained model with the server 100, and may repeat training of the model to reflect local data on the re-acquired global model until a predetermined target performance value is reached.

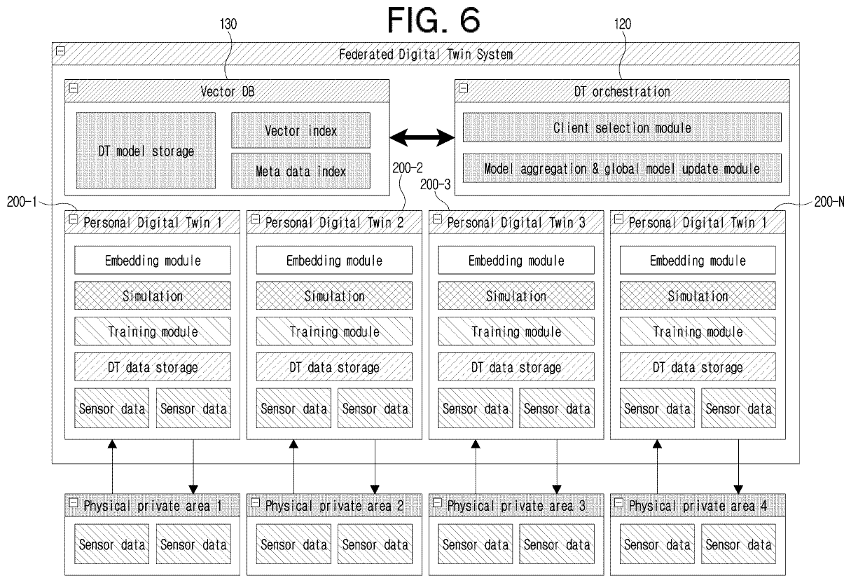

FIG. 5 is a view provided to explain a more detailed configuration of the server 100 according to an embodiment of the disclosure, and FIG. 6 is a view provided to explain more detailed configurations of the server 100 and the client terminals 200 according to an embodiment of the disclosure.

Referring to FIG. 5, the server 100 may include a communication unit 110, a processor 120, and a storage unit 130.

The communication unit 110 is provided with a communication module connected to a network to connect to each client terminal 200 and an Internet network.

Unstructured data may be acquired from a closed circuit television (CCTV), the external server 100.

The storage unit 130 is provided to store programs and data necessary for operations of the processor 120.

Specifically, the storage unit 130 may include a vector database (DB) in which data related to a model repository is stored.

The processor 120 may search a model that has a similarity greater than or equal to a predetermined threshold value in the pre-established model repository based on a user request and embedded data, may generate a global model by aggregating the searched models with weights, and may distribute the global model to a user client and a participating client.

Each of the client terminals 200 (personal digital twin) may include a model storage for individually storing results of training various personalization models as shown in FIG. 6, and may perform a training simulation while owning data for interaction in an isolated local environment, and may share the trained model with the server 100.

In addition, each of the client terminals 200 may extract data features through an embedding module provided therein, and may use the data features for client selection.

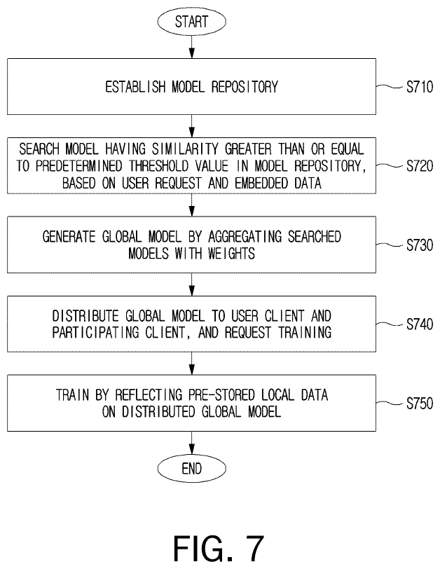

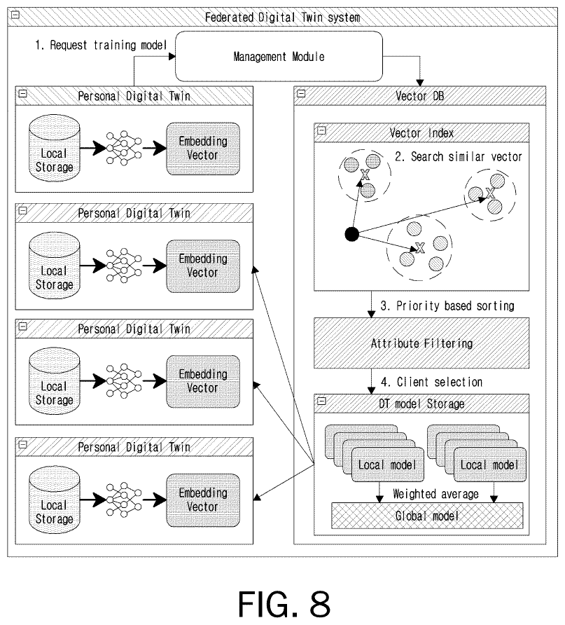

FIG. 7 is a flowchart provided to explain a client training acceleration method based on federated learning for intelligent personalized services according to an embodiment of the disclosure, and FIG. 8 is a view provided to explain a model search process through the system according to an embodiment of the disclosure.

The client training acceleration method based on federated learning for intelligent personalized services according to the present embodiment (hereinafter, referred to as a ‘training method’) may be executed by the system described above with reference to FIGS. 4, 5, and 6.

Referring to FIG. 7, after a model repository is established in the server 100 (S710), when the client terminal 200, which performs the role of the user client, requests training of a personalization model (user request) from the server 100 (embedded data is transmitted to the server 100 when the request is transmitted), the server 100 may search a model that has a similarity greater than or equal to a predetermined threshold value from the model repository based on the user request and the embedded data (S720), and may generate a global model by aggregating the searched models with weights (S730).

Here, the server 100 may convert the features of local resource data into an embedding vector, may compare the embedding vectors and data of the user client (target win) and may filter according to a priority, and may generate the global model through weighted aggregation of selected higher models.

Specifically, when searching models, the server 100 may select a model that has the most similar features and distribution to user data among the models, considering only K tokens that have the highest probability priority in a Top-K method, which is one of parameters of large language model (LLM).

That is, the server 100 may search a similar Top-K model (having a similarity greater than or equal to the predetermined threshold value) from the pre-established model repository based on the received user request and the embedded data, and in this case, the searched model may have similar data features and distribution to user data.

Thereafter, the system may select a participating client corresponding to a participant to participate in training through the server 100, may distribute the global model to the user client and the selected participating client, and may request training of the distributed global model (S740).

Each client terminal 200 corresponding to the user client or the participating client may acquire local data as shown in FIG. 6, and may train the distributed global model to reflect the acquired local data or pre-stored local data and to update to an optimal personalization model (S750).

FIG. 8 illustrates that the server 100 distributes the global model to each client terminal 200 corresponding to the user client or the participating client, and the model trained through each client terminal 200 is shared with the server 100.

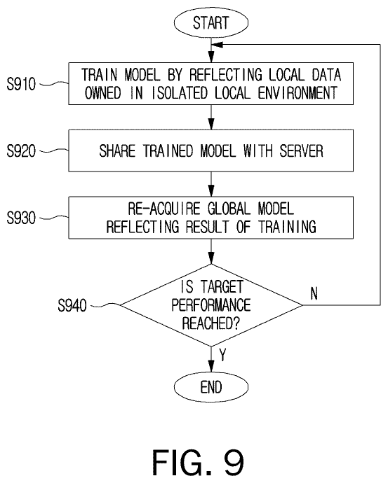

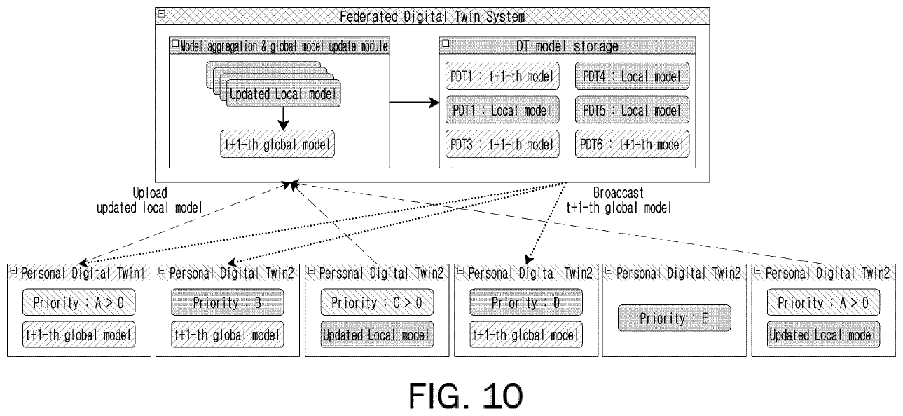

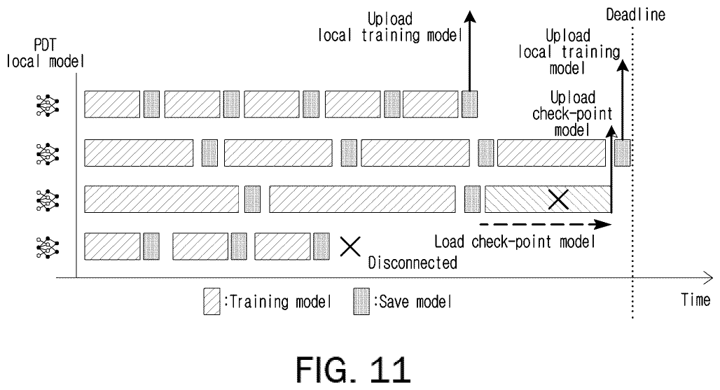

FIG. 9 is a flowchart provided to explain the model training process through the system in more detail according to an embodiment of the disclosure, FIG. 10 is a view provided to explain the model training process through the system according to an embodiment of the disclosure, and FIG. 11 is a view provided to explain a process of sharing the model trained through the system with the server 100 according to an embodiment of the disclosure.

Referring to FIG. 9, when the system trains the global model to reflect pre-stored local data on the distributed global model and to update to the optimal personalization model through each client terminal 200 corresponding to the user client or the participating client, the system may train by reflecting local data owned by each client terminal 200 in an isolated local environment (S910), may share the trained model with the server 100 as shown in FIG. 8 (S920), may re-acquire the global model reflecting the result of training (S930), and may repeat training of the model to reflect the local data in the re-acquired global model until a predetermined target performance value is reached (S940-Y) as shown in FIG. 10.

Specifically, when the global model distributed by the server 100 is trained, each client terminal 200 may train the model according to a deadline requested by the server 100 and requirements on the number of times of training.

In this case, each client terminal 200 may generate a check-point on a model state for every trained model, and may transmit (upload) the generated check point to the server 100 in order to share the trained model with the server 100.

When it is difficult to train a current model within the deadline requested by the server 100 as shown in FIG. 11, each client terminal 200 may transmit (upload) a weight structure of a previously generated check point on the model state to the server 100.

When a result of training by each client is acquired, the server 100 may receive the maximum results of training by the client through a model update structure within the deadline, and, when the global model existing in the server 100 is updated, the server 100 may update the global model according to a weighted average of the results of training by the client.

In this case, the server 100 may update the global model existing in the server 100, and simultaneously, may update the result of training by each client (model check point of the client) with new data in the received model repository and may perform indexing in order to re-generate the global model.

For example, when performing indexing, the server 100 may initialize the priority of the model which has been used for training by the client in order to maintain the result of searching similar clients, and simultaneously, to guarantee diversity of models to participate in training, and may adjust the priority of a model that is not used for training by the client to be higher than before.

That is, the priority of the model that has been used for training may be initialized, and the priority of the other models that are not trained may increase in global updating.

Thereafter, the server 100 may make models reflecting the adjusted priority be a target to be re-researched, so that the result of searching similar clients can maintained and simultaneously the diversity of models to participate in training can be guaranteed.

Specifically, the server 100 may re-research a model that has a similarity greater than or equal to the predetermined threshold value, based on the model for which indexing is performed and an embedding vector according to data features and volumes, may re-generate the global model by aggregating the re-searched models with weights, may re-select a participant, and may re-distribute the global model to each client terminal 200 corresponding to the reselected participating client and the user client.

Each client terminal 200 corresponding to the reselected participating client and the user client may re-acquire the re-distributed global model (reflecting the result of training), and may repeat training of the model until the predetermined target performance value is reached, and, when the corresponding model reaches the predetermined target performance value, the client terminal 200 performing the role of the user client may perform fine-tunning for the corresponding model based on local data, and may use the model as an optimal personalization model (user model).

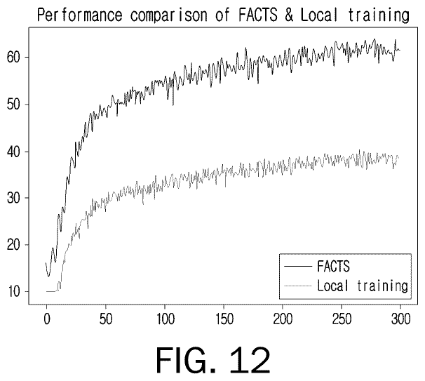

FIG. 12 is a view illustrating a result of comparing performance of a personalization model (FACTS) which is trained through the system according to an embodiment, and performance of a related-art model which is trained based on local data.

Referring to FIG. 12, the generalization performance of the personalization model (FACTS) trained through the present system is higher than the performance of the related-art model trained based on local data.

This is because the model is pre-trained based on data collected in various environments of other clients, which is different from a related-art method biased toward simple local data.

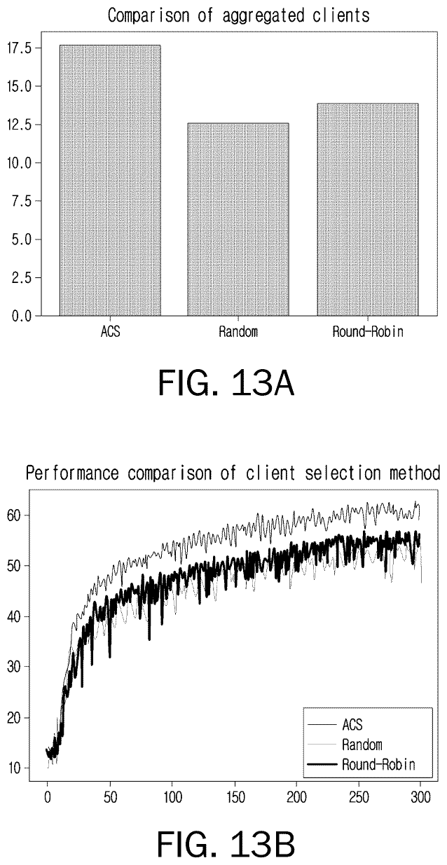

FIG. 13A and FIG. 13B are views illustrating a result of comparing a result of training by a client participating in the training method executed through the system according to an embodiment, and a result of training by a client participating in training based on local data in a related-art method.

Referring to FIG. 13A and FIG. 13B, it can be identified that more clients are aggregated as a result of adaptively training a model by each client terminal 200 participating in the training method executed through the present system, and this results in more enhanced generalization performance of the personalization model.

Up to now, the client training acceleration method based on federated learning for intelligent personalized services has been described in detail with reference to preferred embodiments.

According to embodiments of the disclosure, an AI model cluster which have performed prior federated learning based on data of a plurality of users may be established, a user may select an AI model that is most similar to the data pattern of the user from the cluster and may train a global model in the direction of reducing statistical heterogeneity of global model training, and the global model may be personalized at high speed when the global model is distributed to the user, so that the model can be trained at a low cost and simultaneously high personalization performance can be provided.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A client training acceleration method based on federated learning for intelligent personalized services, the client training acceleration method comprising:
establishing a model repository in a server;
searching, by the server, a model that has a similarity greater than or equal to a predetermined threshold value in the model repository, based on a user request and embedded data;
generating, by the server, a global model by aggregating the searched models with weights;
distributing, by the sever, the global model to a user client and a participating client, and requesting training of the distributed global model; and
training, by each client, the global model to reflect pre-stored local on the distributed global model and to update to an optimal personalization model,
wherein training the global model comprises: training by reflecting local data owned by each client in an isolated local environment; re-acquiring the global model reflecting a result of training by sharing the trained model with the server; and repeating training of the model to reflect local data on the re-acquired global model until a predetermined target performance value is reached.

2. The client training acceleration method of claim 1, wherein searching the model comprises selecting a model that has most similar data features and distribution as user data among models, considering only K tokens that have a highest probability priority in a Top-K method which is one of parameters of large language model (LLM).

3. The client training acceleration method of claim 1, wherein training the global model comprises:
training, by each client, the model according to a deadline requested by the server and requirements on the number of times of training; and
when training the model, generating a check point on a model state for every trained model.

4. The client training acceleration method of claim 3, wherein training the global model comprises, when it is difficult for each client to complete training of the current model within the deadline requested by the server, transmitting a weight structure of the check point on the model state which is previously generated to the server.

5. The client training acceleration method of claim 3, wherein training the global model comprises: acquiring, by the server, the result of training by each client; updating the global model existing in the server, and simultaneously, updating the model check point of each client in the received model repository with new data and performing indexing in order to re-generate the global model.

6. The client training acceleration method of claim 5, wherein training the global model comprises: re-searching a model that has a similarity greater than or equal to the predetermined threshold value, based on the model for which the indexing is performed and an embedding vector according to data features and volumes; and re-generating the global model by aggregating the re-searched models with weights.

7. The client training acceleration method of claim 6, wherein training the global model comprises:
when the result of training by each client is acquired, receiving, by the server, the maximum results of training by the client through a model update structure within the deadline; and
when the global model existing in the server is updated, updating the global model according to a weighted average of the received results of training by the client.

8. The client training acceleration method of claim 7, wherein training the global model comprises: when the indexing is performed, initializing the priority of the model that is used for training by the client in order to guarantee diversity of models to participate in training, and adjusting the priority of the model that is not used for training by the client to be higher than before.

9. The client training acceleration method of claim 8, wherein training the global model comprises, when a model is re-searched, re-searching a model that reflects the adjusted priority in order to guarantee diversity of models to participate in training.

10. A client training acceleration system based on federated learning for intelligent personalized services, the client training acceleration system comprising:
a server configured to search a model that has a similarity greater than or equal to a predetermined threshold value in a pre-established model repository, based on a user request and embedded data, to generate a global model by aggregating the searched models with weights, to distribute the global model to a user client and a participating client, and to request training of the distributed global model; and
a plurality of client terminals configured to perform a role of a user client or a participating client, and to train the global model to reflect pre-stored local on the distributed global model and to update to an optimal personalization model,
wherein, when training the global model, the plurality of client terminals are configured to train the global model by reflecting local data owned by each client in an isolated local environment, to re-acquire the global model reflecting a result of training by sharing the trained model with the server, and to repeat training of the model to reflect local data on the re-acquired global model until a predetermined target performance value is reached.

11. A client training acceleration method based on federated learning for intelligent personalized services, the client training acceleration method comprising:
searching, by a server, a model that has a similarity greater than or equal to a predetermined threshold value in a pre-established model repository, based on a user request and embedded data;
generating, by the server, a global model by aggregating the searched models with weights;
distributing, by the sever, the global model to a user client and a participating client, and requesting training of the distributed global model; and
training, by each client, the global model to reflect pre-stored local on the distributed global model and to update to an optimal personalization model.
